(19) United States
(12) Patent Application Publication
(10) Pub. No.: US 2013/0219156 A1
(43) Pub. Date: Aug. 22, 2013

(54) COMPLIANCE AWARE CHANGE CONTROL

(71) Applicant: Christopher T. Sears, Avondale Estates, GA (US)

(72) Inventor: Christopher T. Sears, Avondale Estates, GA (US)

(73) Assignee: SunGard Availability Services LP, Wayne, PA (US)

(21) Appl. No.: 13/401,923

(22) Filed: Feb. 22, 2012

(51) Int. Cl. G06F 15/177

(52) U.S. Cl. 713/1

(57) ABSTRACT

A Configuration Management System (or CMS) assists with ensuring compliance when changes are proposed to be made to the infrastructure elements of a data center. Configuration state information is collected and stored as a set of features and feature attributes. Specified actions that may be taken with the infrastructure elements are preferably stored in a library. Projected configuration snapshots are determined and compared against compliance policies associated with each infrastructure element. Compliance checks that fail are preferably presented to a user who may then implement additional actions to compensate for the failure and then again request compliance testing. Compliance checks that pass they be stored in a queue waiting to then be further implemented by a human the demonstrator for automated agent when appropriate.

### TECHNICAL FIELD

This patent relates to information technology and in particular to ensuring compliance when changes are made to data center configuration(s).

### BACKGROUND

The data center model for providing Information Technology (IT) services allows customers to run their business data processing systems and applications from a centralized facility. Solutions include hosting services, application services, e-mail and collaboration services, network services, managed security services, storage services and replication services. These solutions are suited to organizations that require a secure, highly available and redundant environment.

Such data centers can be located on the customer's premises and can be operated by customer employees. However, the users of data processing equipment increasingly find a remotely hosted service model to be the most flexible, easy, and affordable way to access the data center functions and services they need. By moving physical infrastructure and applications to cloud based servers accessible over the Internet or private networks, customers are free to specify equipment that exactly fits their requirements at the outset, while having the option to adjust with changing future needs on a “pay as you go” basis.

This promise of scalability allows expanding and reconfiguring servers and applications as needs grow, without having to spend for unneeded resources in advance. Additional benefits provided by professional level cloud service providers include access to the most up to date equipment and software with superior performance, security features, disaster recovery services, and easy access to information technology consulting services.

### SUMMARY

As data center capacity expands to support increasing demand, the complexity of configuring the various hardware and software infrastructure elements that make up the data center environment also grows. As a result, it becomes increasingly difficult to implement configuration changes in a way that does not have unintended consequences, such as violating compliance policies. It is not uncommon for a list of the equipment in even a small data center and configuration settings to specify thousands of pieces of discrete information.

At a general level, this patent is directed to solving these problems using “compliance aware” change control. Configuration information for at least some of the infrastructure elements in a data center is stored as a configuration snapshot. The configuration snapshot may include configuration attributes and associated values for the attributes. One or more planned actions to be taken with infrastructure element are then specified. One or more effects of the planned actions are then applied to the configuration snapshot, resulting in a projected snapshot. The projected snapshot represents a predicted state of at least one configuration attribute if the action were to be taken. The projected snapshot can then be evaluated against a compliance policy that specifies one or more compliance checks and expected corresponding values for the checks, to determine if the proposed action would result in passing or failing at least one compliance check.

In one specific embodiment, a Configuration Management System (or CMS) assists human operators with administering the infrastructure in their data center environments by ensuring compliance with various rules and policies before they are implemented. The CMS is a software program used by an administrative user to track and automate the configuration of a data center. The CMS may be physically located local to or remote from the data center itself.

One major challenge is maintaining an accurate representation of what the correct or desired configuration state should be for the infrastructure elements in the data center. One preferred way is to represent the state information as a hierarchical set of configuration attributes and values. The CMS can then obtain and analyze configuration information in a systematic way.

The data center itself can consist of a number of data processing infrastructure elements such as, but not limited to networking devices such as switches, routers and firewalls, physical data processing machines, virtual machines, storage systems, servers, operating systems and applications.

The specific configuration information collected by the CMS depends on the type of infrastructure elements. For example a file server may return configuration information such as the amount of memory, local disk storage, Operating System (OS) type, OS version, and OS patches installed, applications installed, application versions, and a list of authorized user accounts. A router, on the other hand, may return a list of active interfaces, interface configurations, and routing table information.

The infrastructure elements thus have a live, running configuration state that is queried by the CMS at a specific point in time and stores it as a configuration snapshot in a database. These snapshots are preferably organized into a hierarchical model of the infrastructure elements in the data center, with one or more configuration attributes for each infrastructure element and associated values for the attributes.

The CMS can then further track and automate the configuration of data center infrastructure. Specifically, this feature helps validate changes being requested by a human operator or customer against configuration compliance policies. These policies can for example, be based on company security standards, application requirements or regulatory programs such as Payment Card Industry Data Security Standard (PCI), Health Insurance Portability and Accountability Act (HIPAA), or the Federal Information Security Management Act (FISMA) or similar compliance standards.

If the CMS detects that the requested change might cause the IT environment to become non-compliant, a warning is displayed to the user with details of the potential problem.

The CMS can also automate the compliance-checking aspect of an Information Technology Infrastructure Library (ITIL) change control review process, which has often in the past been handled manually by a Change Advisory Board (CAB). In service provider environments where changes can be initiated by customers (self-service model), the traditional change control process as described by ITIL may not be practical due to time constrains and organizational boundaries. By automatically checking the expected results of a change against configuration compliance policies before actually making the change, this feature lowers the risk of security failures and application outages.

The compliance policy feedback can be integrated into the user interface of the CMS, providing some of the benefits of a Change Advisory Board but without sacrificing the convenience and speed of self-service tools.

During the initial feature configuration within the CMS, an internal operator typically defines the compliance policies in the CMS. The operator may define a policy by loading a policy specification file provided by a customer, security vendor or regulatory group. Alternatively, the operator may use a policy editing tool in the CMS to manually define the checks, expected values and associated metadata needed to perform a custom compliance scan. An operator can also combine these methods and adapt a generic policy with custom logic or additional checks needed for a specific customer or application.

Once the required policies have been defined in the CMS, an end user or internal operator then associates a compliance policy with one or more infrastructure elements. This association informs the CMS that the infrastructure elements are expected to comply with the policy.

Next the CMS begins monitoring the compliance status of the infrastructure elements by collecting periodic configuration snapshots of their live state. These snapshots capture all the configuration attributes and values needed to evaluate the checks contained in the associated compliance policy. In a typical embodiment this snapshot may comprise a hierarchical model of several infrastructure elements in the data center, attributes for the elements, and values for the attributes.

If an infrastructure element is found to not comply with its associated policy, an internal operator or end user is expected to either make the configuration changes needed to bring the infrastructure element back into compliance, or adjust the policy to eliminate any false positive checks. In both cases, the infrastructure element must reach a compliant steady state before any future configuration changes are made which require compliance awareness.

At a later date, an internal operator or end user returns to the CMS to plan a configuration change for one or more infrastructure element with associated compliance policies. This change involves one or more proposed actions to be executed on the infrastructure elements. These actions are selected from a library of administrative tasks and operations defined in the CMS.

Once the internal operator or end user has specified the planned change, the CMS can evaluate the expected compliance status of the infrastructure elements after the change has been executed through projection process. Each proposed action is applied to the current snapshot to obtain a projected snapshot. By applying an action, the current configuration attributes and values are transformed in a predefined way to produce a new, projected set of attributes and values.

The resulting projected snapshot is then evaluated against the associated compliance policy to produce an expected post-change compliance status. This status is displayed to the end user or internal operator. If the planned changes results in a non-compliant expected configuration, the operator may choose to abandon the change, adjust the change to achieve compliance, adjust the policy to achieve compliance, or ignore the result and proceed with the change.

Adjusting the change to achieve compliance can take many forms. In some situations, rather than adjusting the non-compliant attribute directly, the end user or internal operator may choose to employ a compensating control which supersedes the non-compliant attribute and effectively achieves compliance.

The state information comprising the snapshot may originate from a number of different elements for example it may include virtual machine definition files, virtual registry elements and so forth.

In some embodiments, the compliance check files may take standard formats such as Open Vulnerability and Assessment Language (OVAL).

In a specific embodiment, the compliance check may be a rule that specifies ranges within which the values must remain for the check to result in compliance.

Further embodiments will be described in greater detail below.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a high level diagram of a service provider level data processing environment that includes several data centers operated as a service for customers.

FIG. 2 is an example process flow for implementing compliance aware change according to one embodiment.

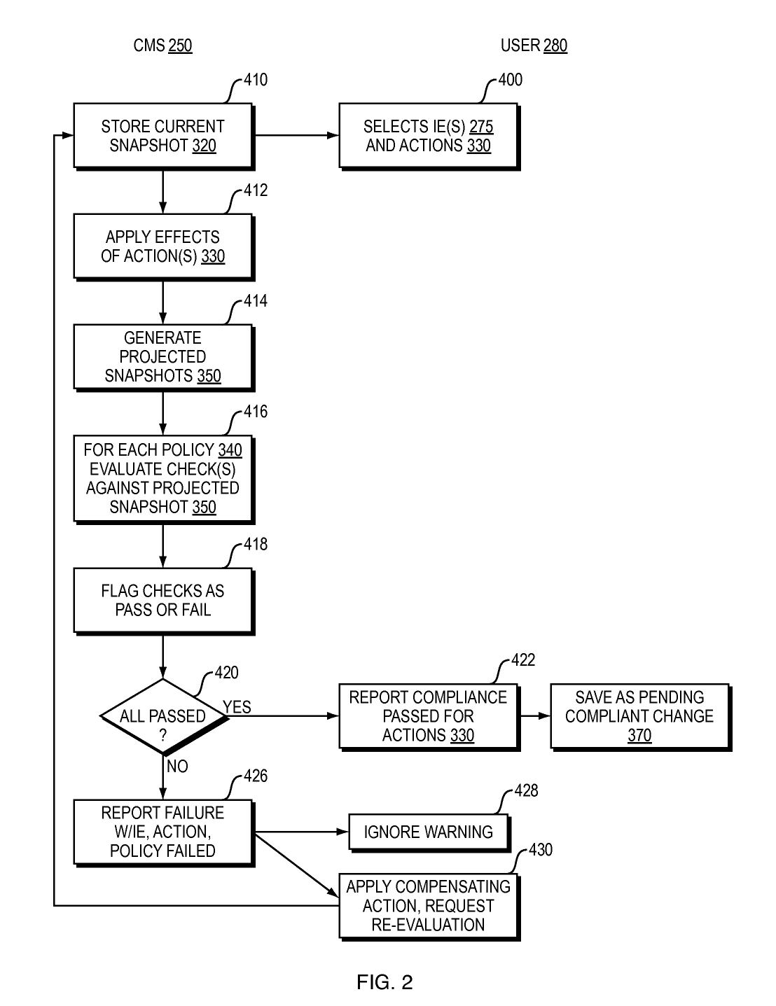

### DETAILED DESCRIPTION OF AN EMBODIMENT

### Example Data Center

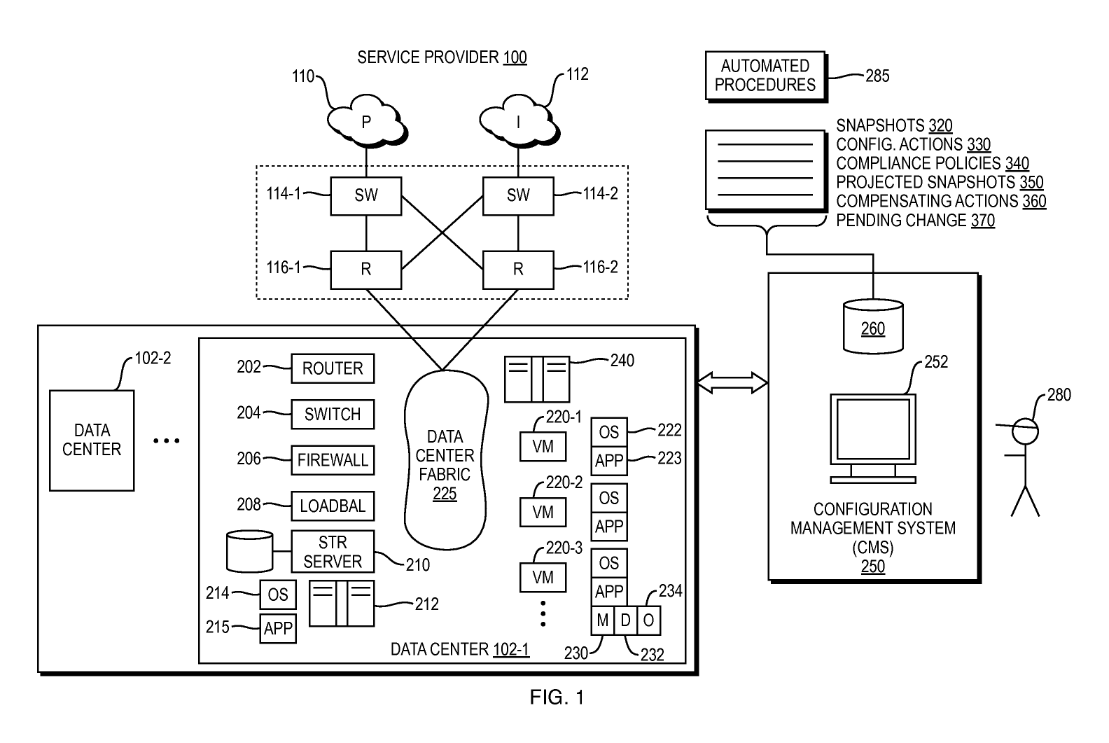

FIG. 1 is a high level diagram of a typical information technology (IT) environment in which the improved Configuration Management System (CMS) procedures described herein may be used. It should be understood that this is but one example IT environment and many others are possible.

The illustrated IT environment is implemented at a service provider location 100 which makes available one or more data centers 102-1, 102-2 . . . to one or more service customers. The service provider environment includes connections to various networks such as a private network 110 and the Internet 112 through various switches 114-1, 114-2 and or routers 116-1, 116-2. The data center level switches 114 and routers 116 provide all ingress and egress to the several various data centers 102-1, 102-2 that are hosted at the particular service provider location 100.

In some implementations, these data center level switches 114 and routers 116 are considered to be part of the service provider's infrastructure and thus are not considered to be part of the infrastructure elements that are configurable by the customer directly or considered to be part of the data center 102. It is, for example, possible that the details of the operation of the service provider level switches 114 and routers 116 are kept hidden from and are not of concern to the customer. However, in other instances the data center level switches and routers (or portions thereof) may very well be part of the service customer's infrastructure elements and therefore configurable by the customer.

An example data center 102 includes a number of physical and/or virtual infrastructure elements. These infrastructure elements may include, but are not limited to, networking equipment such as routers 202, switches 204, firewalls 206, and other equipment such as load balancers 208, storage subsystems 210, and servers 212. The servers 212 may include web servers, database servers, application servers, storage servers, security appliances or other type of machines. Each server 212 typically includes an operating system 214, application software 215 and other data processing services, features, functions, software, and other aspects.

Most modern data centers also support virtual machine clusters 240 that may be implemented on one or more physical machines, such that multiple virtual machines 220-1, 220-2, 220-3 are also considered to be part of the data center 102. Each of the VM's 220 typically includes an operating system 222 and applications 223 and has access to various resources such as memory 230, disk storage 232 and other resources 234, such as virtual local area networks, firewalls, and so forth.

A data center fabric 225 interconnects the various infrastructure elements in the data center 102 and is not shown in detail for the sake of clarity.

It should also be understood that while shown only a single type of each infrastructure element is shown, a given data center may have multiple routers 202, switches 204, firewalls 206, load balancers 208, storage servers 210, application servers 212, virtual machines 220 and virtual machine clusters 240 and/or other types of infrastructure elements that are not shown or mentioned in detail or at all herein. For example, the virtual machine 220 infrastructure elements may provide functions such as virtual routers, virtual network segments, with each segment having one or more virtual machines operating as servers and/or other virtualized resources such as virtual firewalls.

An administrative user 280 has access to a Configuration Management System 250. The CMS 250 allows the administrator user 280 to interact with and configure the infrastructure elements in the data center 102.

The CMS 250 may itself be located in the same physical location as the data center 102, elsewhere the premises of the service provider 100, at the service customer premises, or remotely located and securely accessing the data center through either the private network 110 or the Internet 112.

The CMS 250 includes a user input/output device 252 such as a personal computer and access to information storage, preferably taking the form of a configuration database 260, as will be understood and described in more detail shortly. The database 260 stores several different types of information concerning the data center 102. Of particular interest here is that the database 260 stores configuration snapshots 320 (configuration information taken from and relating to the various infrastructure elements in the data center 102), configuration actions 330 (representing a library of configuration changes that may represent operational tasks to be performed by a network or server administrator), compliance policies 340 (typically consisting of one or more checks that you value a different aspects of infrastructure elements to determine if those attributes comply with expected configuration values) and projected snapshots 350 (that result from the CMS taking a copy of a configuration snapshot 320 and applying the effects of one or more configuration actions). Each of these data elements manipulated by the CMS 250 is described in greater detail below.

The configuration management system 250 may also include or have access to other system administration aspects such as automated procedure systems 285 that perform functions such as security, maintenance, automatic updates and so forth that normally occur without intervention from the administrator user 280. Automated systems 285 include but are not limited to monitoring systems, alerting services, intrusion detection systems, and log analysis services.

Configuration Snapshots 320

The CMS 250 thus maintains for each data center 102 one or more configuration snapshots 320. The CMS 250 is therefore capable of capturing live, running configuration information from the data center infrastructure elements and storing this configuration information. These configuration information snapshots may take a general hierarchical structure consisting of a nested list of the infrastructure elements 275 of interest in a data center 102, a set of attributes related to those elements and attribute values. The exact configuration of the hierarchy including the number of infrastructure elements, the attributes and the attribute values will of course depend upon the configuration of the data center and aspects of the data center that are considered important for the system administrator to ensure compliance.

For example if the infrastructure elements is a database server, the configuration attribute information may include an amount of memory, disk size, operating system, operating system version, operating system patches installed, the database application, a list of authorized login accounts, and other information. Snapshot 320 information for an infrastructure element that is a communication device such as a switch may include, for example, a list of active ports, associated host names, and universally unique IDs. A more specific example is discussed in greater detail below.

It should be understood that the types of infrastructure elements to which the principles described herein apply may be different, and therefore the types of configuration information stored in each snapshot 320 is also different depending not only on the data center configuration and the specific infrastructure elements, but also the preferences of the designer of the configuration management system and/or administrative user 280. These details are not a feature of the primary aspect of what is believed to be novel.

During operation, the CMS 250 thus collects configuration snapshot 320 data on at least some of the infrastructure elements in the data center. This configuration data is organized into a hierarchical model of elements with attributes and values. The CMS also keeps track of any compliance policies that a customer has requested apply to infrastructure elements in their environment. A snapshot of this data captures the configuration at a certain point of time.

Consider one example of a Windows Server 2008 virtual machine called “webapp01” which must comply with the US Department of Defense Information Systems Agency (DISA) Security Technical Implementation Guide (STIG) configuration policy. The initial configuration snapshot 320 might look like the following JavaScript Object Notation (JSON) fragment in Listing 1:

Listing 1 - Example VM configuration snapshot in JSON format

```
{
  name: “webapp01”,
  os: “Windows Server 2008”,
  service_pack: 1,
  users: [...],
  services: [...],
  compliance_policies: [
    {policy_name: “DISA STIG - Windows 2008 Member Server”}
  ],
  registry_data: [
    {key: “HKLM\Software\Policies\Microsoft\Windows NT\Terminal
Services\fEncryptRPCTraffic”, value: 1},
    {...}
  ]
}
```

Note that methods of capturing and representing configuration snapshot data are not critical to obtaining the primary benefits of the preferred embodiments described herein.

### Library of Configuration Change Actions 330

The CMS also contains a library of configuration change actions 330. Each such action represents an operational task that might be performed on an infrastructure element by a network, storage or server administrator. The CMS 250 track the prerequisites and effects of each action in the library 330. An example action for installing an update known as “Service Pack 2” for Windows 2008 might look like Listing 2:

Listing 2 - Example action definition 330 in JSON format

```
{
  name: “Install Service Pack 2 for Windows Server 2008”,
  installer_file: “\\files\windows\win-2008-sp2-setup.exe”,
  applies_to: “virtual machine”,
  requires_reboot: True,
  prerequisites: [
    {os: “Windows Server 2008”},
    {service_pack: 1}
  ],
  effects: [
    {service_pack: 2},
    {registry_data: [
      {key: “HKLM\Software\Policies\Microsoft\Windows NT\Terminal
Services\fEncryptRPCTraffic”, value: 0}
    ]}
  ]
}
```

In Listing 2, we see that the action 330 applies to virtual machines and requires that they be running Windows 2008 with service pack 1 before performing the change. The action has a main effect, namely changing the service pack from version 1 to version 2, but it also has another side effect of setting the registry key “HKLM\Software\Policies\Microsoft\Windows NT\Terminal Services\fEncryptRPCTraffic” to the value 0.

While this is but one example, but it is common for service packs and updates to have such side effects and resulting issues. These are frequently documented by the vendor and could be entered into the CMS 250.

### Compliance Policies and Checks 340

A third type of information accessed by the CMS 250 is configuration compliance policy definitions 340, which are made up of one or more checks. These checks can evaluate many different aspects of servers, operating systems, network devices and storage systems to determine if specific attributes comply with expected configuration values.

A common way to express these checks is an XML-based format called the Open Vulnerability and Assessment Language, or (OVAL). Vendors, regulatory groups, and government agencies provide OVAL files to define configuration objectives that must be met to comply with a particular security or regulatory policy.

To illustrate one example, consider the metadata for a single check from the Windows Server 2008 Member Server OVAL file provided by the Defense Information Systems Agency (DISA), available at http://iase.disa.mil/stigs/os/windows/u_windows_{—}2008_ms_v6r1.16_stig_benchmark_{—}2 0111028.zip.

Listing 3 - Example OVAL policy check 340 content adapted
from DISA STIG for Windows 2008

```
<oval_definitions>
  <definitions>
    <definition id=“oval:mil.disa.fso.windows:def:2470” version=“1”
            class=“compliance”>
      <metadata>
        <affected family=“windows”>
          <platform>Microsoft Windows Server 2008</platform>
        </affected>
      </metadata>
      <criteria operator=“OR”>
        <criterion test_ref=“oval:mil.disa.fso.windows:tst:247000”/>
      </criteria>
    </definition>
  </definitions>
  <tests>
    <registry_test id=“oval:mil.disa.fso.windows:tst:247000”
    version=“1”
              check=“all”>
      <object object_ref=“oval:mil.disa.fso.windows:obj:247000”/>
      <state state_ref=“oval:mil.disa.fso.windows:ste:240400”/>
    </registry_test>
  </tests>
  </objects>
    <registry_object id=“oval:mil.disa.fso.windows:obj:24700”
    version=“1”
    comment=“Configure the Terminal Server to require secure RPC
communication”>
      <hive datatype=“string”
      operation=“equals”>HKEY_LOCAL_MACHINE</hive>
      <key datatype=“string” operation=“equals”>
          Software\Policies\Microsoft\Windows
          NT\Terminal Services</key>
      <name datatype=“string”
      operation=“equals”>fEncryptRPCTraffic</name>
    </registry_object>
  </objects>
  <states>
    <registry_state id=“oval:mil.disa.fso.windows:ste:240400”
    version=“1”>
      <value datatype=“int” operation=“equals”>1</value>
    </registry_state>
  </states>
</oval_definitions>
```

The simplified OVAL XML document in Listing 3 shows the check metadata for a security setting of the Terminal Services component of Windows. The definition element “oval:mil.disa.fso.windows:def:2470” is the entry point for the check. It references one test element to evaluate: “oval:mil.disa.fso.windows:tst:247000”. That test ties together an object, “oval:mil.disa.fso.windows:obj:24700”, with an expected state, “oval:mil.disa.fso.windows:ste:240400”. The registry_object element identifies a location in the Windows registry to look up the value. The registry_state element specifies the desired value of the registry key, in this case the integer 1.

Note that OVAL is an existing standard and is but one possible way to define compliance policies. The process of validating live, running systems against an OVAL file using a scanning tool is not part of what is claimed to be novel.

### Process for Requesting and Validating a Change

A human user, either a customer or internal operator, uses the user interface of the CMS 250 to initiate a change request and validate the same. In one implementation, an automated process interacts with the user proceeding as follows:
1. In specifying the details of the change, the user select one or more target infrastructure elements 275 and specify one ore more actions from the action library 330.
2. For each infrastructure element 275, the CMS 250 creates a copy of the most recent configuration snapshot 320 and applies the effects of each specified action 330, resulting in a projected configuration snapshot 350. This projected snapshot 350 (using the same general format as the configuration snapshot 320 but no representing a transformation of the original snapshot 320 with the change applied) now represents a predicted configuration state of the infrastructure element(s) 275 after the change.
3. For each compliance policy 340 attached to each element 275, the CMS 250 performs a simulated evaluation of the compliance checks against the projected snapshot. Each check will result in a status of, for example, “Passed” or “Failed”.
4. For any “Failed” checks, a detailed warning can then be presented to the user 280. This detail will include information on the infrastructure element 275 and action 330 at issue, along with the policy 340 and specific check that failed.
5. The user 280 may choose to abort the change, ignore the warnings and continue with the change-as-is, or add some additional compensating actions 360 that compensate for the compliance failure. The compensating actions 360 are represented using the same general format as configuration actions 330.
6. If the user adds compensating actions 360, the CMS 250 will go back to step 2 and re-evaluate the new change. If the correct compensating action was added, the compliance checks 340 should now all pass.
7. The change request would be saved in the CMS 250 as a pending change 370, waiting to be processed either by a human operator 280 or an automated agent 285 that would perform the actions on the specified elements. The pending change may also be represented in the same general format as the configuration actions 330.

### Example

### Installing Service Pack 2 on webapp01

Consider the further example where a customer is requesting the Windows update “Service Pack 2” be installed on the VM named webapp01, which has the DISA STIG Windows 2008 Member Server policy attached. This example builds on the previous JSON and XML listings in the Listings above.

The user 280 creates a new change request from the CMS user interface. He selects webapp01 as the target element and specifies “Install Service Pack 2 for Windows 2008” as the action.

The CMS 250 creates a copy of the most recent configuration snapshot 320 and applies the effects of the Service Pack 2 action 330. The resulting projected snapshot 350 would look like the following:

Listing 4 - Example of projected snapshot 350 after
example action in JSON format

```
{
  name: “webapp01”,
  os: “Windows Server 2008”,
  service_pack: 2,
  users: [...],
  services: [...],
  compliance_policies: [
    {policy_name: “DISA STIG - Windows 2008 Member Server”}
  ],
  registry_data: [
    {key: “HKLM\Software\Policies\Microsoft\Windows NT\Terminal
Services\fEncryptRPCTraffic”, value: 0},
    {...}
  ]
}
```

Now the CMS 250 performs a simulated evaluation of the DISA STIG Windows 2008 Member Server policy 340. In this simplified example, this policy just contains the one Terminal Services check, expecting the fEncryptRPCTraffic value to be 1. Since the projected value is 0, the check fails, indicating that the change would cause the infrastructure element to become non-compliant.

The following warning could then displayed to the user 280:

Warning: Compliance Violation Detected
The VM “webapp01” may no longer be in compliance with policy “DISA STIG—Windows 2008 Member Server” after performing the action “Install Service Pack 2 for Windows 2008”.

Failed Checks:
Registry key “HKLM\Software\Policies\Microsoft\Windows NT\Terminal Services\fEncryptRPCTraffic” should have the value 1, but the projected value is 0. [oval:mil.disa.fso.windows:def:2470]

Do you want to abort, ignore and continue, or add a compensating action?

The user 280 can then choose to add a compensating action 360, specifically to set the fEncryptRPCTraffic registry value back to 1 immediately after service pack 2 is installed.

It should be understood that the compensating action 360 may either originate from knowledge that the user 280 has from personal past experience, information obtained from other sources such as other expert users or information coded in the database 260.

Furthermore, the compensating action 360 may result from observing an existing state of a different infrastructure element already provides the required compliance in spite of the tested infrastructure element having failed. An examples for this may for example be a situation where one infrastructure element such as a virtual machine (VM) is to limit outside access to the data center from unauthorized external devices, however a different infrastructure element, such as a firewall, already provides the required port blocking control in spite of the failed configuration change to the VM.

The CMS 250 is then asked to re-evaluate the compliance policy 340 and all checks now pass. The user 280 submits the change request such as to the pending change queue 370, having proactively avoided taking webapp01 out of compliance due to an obscure side effect.

It should be understood that the example embodiments described above may be implemented in many different ways. In some instances, the various “data processors” described herein may each be implemented by a physical or virtual general purpose computer having a central processor, memory, disk or other mass storage, communication interface(s), input/output (I/O) device(s), and other peripherals. The general purpose computer is transformed into the processors and executes the processes described above, for example, by loading software instructions into the processor, and then causing execution of the instructions to carry out the functions described. As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

The computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing resources as part of a shared marketplace. By aggregating demand from multiple users in central locations, cloud computing environments can be built in data centers that use the best and newest technology, located in the sustainable and/or centralized locations and designed to achieve the greatest per-unit efficiency possible.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

Thus, while this invention has been particularly shown and described with references to example embodiments thereof, it will be understood by those skilled in the art that various changes in form and details may be made therein without departing from the scope of the invention as encompassed by the appended claims.

What is claimed is:

1. A method for compliance aware change control in a data center, where the data center includes two or more infrastructure elements, the method comprising:
determining configuration information for at least some of the infrastructure elements of the data center to create a configuration snapshot, the configuration snapshot including configuration attributes and associated values for the attributes;
receiving information specifying one or more planned actions to be taken with an infrastructure element;
applying one or more effects of the planned actions to the configuration snapshot, resulting in a projected snapshot representing a predicted state of at least one configuration attribute if the one or more planned actions were to be taken; and
evaluating the projected snapshot against a compliance policy, the compliance policy specifying one or more compliance checks and expected corresponding values for the checks, to determine if one or more of the planned actions would result in passing or failing at least one compliance check.

2. The method of claim 1 additionally comprising reporting that a compliance policy failure would occur if one or more of the planned actions were to be taken.

3. The method of claim 1 wherein the compliance checks further comprise one or more rules that specifies a range within which values for configuration attributes must fall.

4. The method of claim 1 wherein the infrastructure elements include one or more of a physical data processing machine, virtual machine, networking device, switch, router, firewall, storage device, or other data processing function.

5. The method of claim 2 additionally comprising:
accepting information specifying one or more compensating actions to be taken as a result of a compliance policy failure.

6. The method of claim 5 additionally comprising:
determining a new configuration snapshot;
applying the one or more compensating actions to the configuration snapshot, resulting in a revised projected snapshot;
evaluating the revised projected snapshot against at least one compliance policy, to determine if the revised projected snapshot would result in passing or failing the previously failed compliance check.

7. The method of claim 5 wherein the compensating action determines if the compliance policy is otherwise complied with given attributes of an other infrastructure element in the configuration snapshot.

8. The method of claim 1 wherein the configuration snapshot comprises information concerning attributes and attribute values for at least one virtual machine in the data center.

9. The method of claim 1 wherein the configuration snapshot comprises information extracted from a registry file associated with at least one active infrastructure elements in the data center.

10. The method of claim 1 wherein the compliance checks are specified as OVAL compliant files.

11. The method of claim 1 additionally comprising:
if at least one of the planned actions passes the compliance check, storing it in a queue of actions to be taken later.

12. An apparatus for compliance aware change control in a data center, where the data center includes two or more infrastructure elements, the apparatus comprising:
a storage device, for storing configuration information for at least some of the infrastructure elements as a configuration snapshot, the configuration snapshot including configuration attributes and associated values for the attributes;
a user interface, for receiving information specifying a planned action to be taken with an infrastructure element;
a processor that:
determines one or more effects of the planned action upon the configuration snapshot;
outputs a projected snapshot representing a predicted state of at least one configuration attribute if the planned action were to be taken; and
evaluates the projected snapshot against a compliance policy, the compliance policy specifying one or more compliance checks and expected corresponding values for the checks, to determine if one or more of the planned actions would result in passing or failing at least one compliance check.

13. The apparatus of claim 12 wherein the user interface additionally reports that a compliance policy failure would occur if one or more of the planned actions were to be taken.

14. The apparatus of claim 12 wherein the compliance checks further comprise one or more rules that specifies a range within which values for configuration attributes must fall.

15. The apparatus of claim 12 wherein the infrastructure elements include one or more of a physical data processing machine, virtual machine, networking device, switch, router, firewall, storage device, or other data processing function.

16. The apparatus of claim 12 wherein the user interface additionally accepts information specifying one or more compensating actions to be taken as a result of a compliance policy failure.

17. The apparatus of claim 16 wherein the processor further:
determines a new configuration snapshot;
applies the one or more compensating actions to the configuration snapshot, resulting in a revised projected snapshot; and
evaluates the revised projected snapshot against at least one compliance policy, to determine if the revised projected snapshot would result in passing or failing the previously failed compliance check.

18. The apparatus of claim 16 wherein the compensating action determines if the compliance policy is otherwise complied with given attributes of an other infrastructure element in the configuration snapshot.

19. The apparatus of claim 12 wherein the configuration snapshot comprises information concerning attributes and attribute values for at least one virtual machine in the data center.

20. The apparatus of claim 12 wherein the configuration snapshot comprises information extracted from a registry file associated with at least one active infrastructure elements in the data center.

21. The apparatus of claim 12 wherein the compliance checks are specified as OVAL compliant files.

22. The apparatus of claim 12 additionally comprising:
a queue for storing a corresponding action to be taken later, if the planned action passes the compliance check.
